(19) United States
(12) Patent Application Publication
(10) Pub. No.: US 2025/0369493 A1
(43) Pub. Date: Dec. 4, 2025

(54) DOUBLE RETRACTION ARM BRAKE PAD RETENTION CLIPS AND DISC BRAKE APPARATUS INCLUDING SAME

(71) Applicant: HL MANDO CORPORATION, Pyeongtaek-si (KR)

(72) Inventor: Satish Ramchandra KOLEKAR, Farmington, MI (US)

(21) Appl. No.: 18/678,932

(22) Filed: May 30, 2024

(51) Int. Cl. F16D 65/097

(52) U.S. Cl. CPC F16D 65/0978

(57) ABSTRACT

A brake pad retention clip for supporting a disc brake pad in a brake pad carrier includes a lower guide portion configured to slidably receive a first support tab extending from an end portion of a brake pad backing plate, an upper guide portion configured to slidably receive a second support tab extending from the end portion of the brake pad backing plate, and an intermediate portion connecting the lower guide portion and the upper guide portion. The intermediate portion is configured to secure the brake pad retention clip to the brake pad carrier. The lower guide portion includes a first biasing member configured to contact the first support tab, and the upper guide portion includes a second biasing member configured to contact the second support tab.

### FIELD

The present inventive concept relates generally to vehicle brakes and, more particularly, to vehicle disc brakes.

### BACKGROUND

A vehicle disc brake system, such as a floating-type caliper brake system 10 illustrated in FIGS. 1A-1C, includes a brake disc 15 (also called a rotor) that is connected to a vehicle wheel, a caliper 22, a brake pad carrier 24, and two or more brake pads, such as an inner or inboard brake pad 32 and an outer or outboard brake pad 34 on opposing sides of the rotor 15. The brake pads 32, 34 are mounted within the caliper 22 so that the brake pads 32, 34 can move axially, along a rotor axis, a piston bore axis, or both, toward and away from the rotor 15.

For example, as illustrated in FIG. 1B, when a vehicle brake is applied by an operator of the vehicle, hydraulic fluid flows into the caliper 22 via conduit C and forces a piston (not shown) outward. This outward movement of the piston forces the inner brake pad 32 into contact with the inboard surface of the rotor 15, and also creates a rearward force that causes the caliper 22 to move axially along the guide rods 26 relative to the brake pad carrier 24 (as indicated by arrow BA in FIG. 1B) which forces the outer brake pad 34 against the opposing outboard surface of the rotor 15. Pressing the brake pads 32, 34 against the rotor 15 causes braking of the wheel. When the brake pedal is released, the hydraulic fluid flows out of the caliper 22, thereby allowing the piston to retract and release the inner brake pad 32 from contacting the rotor 15. As the piston retracts, the caliper 22 moves in the opposite direction along the guide rods 26 and relative to the brake pad carrier 24 (as indicated by arrow BR in FIG. 1C) which pulls the outer brake pad 34 away from the rotor 15, thereby allowing the rotor 15 to rotate relative to caliper 22.

There is an ongoing need to reduce residual brake drag in disc brake systems caused by unwanted contact between brake pads and a rotor in non-braking conditions. In the current market, in which manufacturers are moving towards electrification, battery life is a major focus point. In electric vehicles, drag caused by brake pads contacting a rotor when braking is not needed may reduce battery life. For example, it has been estimated that battery life may be reduced by about 0.5 mile per 1 Nm drag per disc brake caliper.

In current floating-type caliper designs, a spring may be utilized to assist in retracting an outer brake pad away from a rotor when the brakes are released. However, the spring retraction force may be insufficient to move the brake pad carrier and caliper away from each other such that the outer brake pad is completely retracted from the rotor. For example, when the spring retraction force is less than the sliding friction force between the rotor and the brake pads, brake drag may occur because of unwanted contact even in non-braking conditions. As such, some brake pad drag may still occur with current floating-type caliper designs.

### SUMMARY

According to some embodiments of the present inventive concept, a brake pad retention clip is configured to support a disc brake pad in a brake pad carrier. The disc brake pad has a backing plate with opposing end portions, and each end portion has first and second support tabs extending outward therefrom in adjacent, spaced apart relationship. The brake pad retention clip includes a lower guide portion configured to slidably receive the first support tab of one of the backing plate end portions, an upper guide portion configured to slidably receive the second support tab of the one of backing plate end portions, and an intermediate portion connecting the lower guide portion and the upper guide portion. The intermediate portion is configured to secure the brake pad retention clip to the brake pad carrier. The lower guide portion includes a first biasing member configured to contact the first support tab, and the upper guide portion includes a second biasing member configured to contact the second support tab. The first and second biasing members serve as retraction arms for moving the disc brake pad away from the rotor when vehicle braking is no longer desired. During a braking operation, the disc brake pads are pressed against the rotor and, thus, move within the lower and upper guide portions of the respective brake pad retention clips such that the first and second support tabs press against the first and second biasing members causing the first and second biasing members to bend or flex. Once the braking operation is ended, the first and second biasing members return to their relaxed configuration and urge the disc brake pads away from the rotor.

In some embodiments, the first biasing member is a first deflectable spring arm having a distal free end that is configured to contact the first support tab, and the second biasing member is a second deflectable spring arm having a distal free end that is configured to contact the second support tab.

In some embodiments, the distal free end of the first spring arm has an arcuate configuration, and the distal free end of the second spring arm has an arcuate configuration.

In some embodiments, the first and second spring arms extend inward toward a centerline of the brake pad retention clip.

In some embodiments, the first and second spring arms are substantially parallel.

In some embodiments, the first and second spring arms have substantially the same length.

In some embodiments, the intermediate portion includes opposing arms that are configured to engage a portion of the brake pad carrier.

In some embodiments, the lower guide portion includes a stop that is configured to limit a distance the first support tab can move within the lower guide portion.

In some embodiments, the brake pad retention clip is formed as a single unitary body.

According to some embodiments of the present inventive concept, a disc brake pad includes a backing plate having opposing end portions and an inner surface. Each end portion includes first and second support tabs extending outward therefrom in adjacent, spaced apart relationship. Friction material is on the inner surface of the backing plate.

In some embodiments, the first and second support tabs extending outward from each end portion of the backing plate are coplanar with the backing plate.

In some embodiments, the first support tab has a length greater than a length of the second support tab.

According to some embodiments of the present inventive concept, a disc brake assembly includes a brake pad carrier, a first pair of brake pad retention clips secured to the brake pad carrier in spaced apart relationship, a first disc brake pad movably supported within the brake pad carrier by the first pair of brake pad retention clips, a second pair of brake pad retention clips secured to the brake pad carrier in spaced apart relationship, and a second disc brake pad movably supported within the brake pad carrier by the second pair of brake pad retention clips. The first and second disc brake pads are supported within the brake pad carrier in spaced apart relationship such that a rotor associated with a vehicle wheel can be positioned therebetween. Each of the first and second disc brake pads includes a backing plate having opposing end portions, an inner surface, and friction material on the inner surface. Each end portion includes first and second support tabs extending outward therefrom in adjacent, spaced apart relationship.

Each brake pad retention clip includes a lower guide portion that is configured to slidably receive the first support tab of one of the backing plate end portions, and an upper guide portion configured to slidably receive the second support tab of the one of backing plate end portions. The lower guide portion includes a first biasing member configured to contact the first support tab, and the upper guide portion includes a second biasing member configured to contact the second support tab. Each brake pad retention clip further includes an intermediate portion that connects the lower guide portion and the upper guide portion The intermediate portion is configured to secure the brake pad retention clip to the brake pad carrier.

In some embodiments, the first biasing member of each brake pad retention clip is a first deflectable spring arm having a distal free end that is configured to contact the first support tab, and the second biasing member of each brake pad retention clip is a second deflectable spring arm having a distal free end that is configured to contact the second support tab.

In some embodiments, the distal free end of the first spring arm of each brake pad retention clip has an arcuate configuration, and the distal free end of the second spring arm of each brake pad retention clip has an arcuate configuration.

In some embodiments, the first and second spring arms of each brake pad retention clip extend inward toward a centerline of the brake pad retention clip and are substantially parallel.

In some embodiments, the first and second spring arms of each brake pad retention clip have substantially the same length.

In some embodiments, the intermediate portion of each brake pad retention clip has opposing arms configured to engage a portion of the brake pad carrier.

In some embodiments, the lower guide portion of each brake pad retention clip includes a stop configured to limit a distance the first support tab can move within the lower guide portion.

Brake pad retention clips, according to embodiments of the present inventive concept, are advantageous because the double spring arm configuration facilitates the retraction of disc brake pads away from a rotor when braking is no longer desired, thereby substantially reducing drag. As such, electric vehicles incorporating disc brake apparatus with the brake pad retention clips of the present inventive concept may achieve longer battery life than electric vehicles with conventional disc brake apparatus.

It is noted that aspects of the present inventive concept described with respect to one embodiment may be incorporated in a different embodiment although not specifically described relative thereto. That is, all embodiments and/or features of any embodiment can be combined in any way and/or combination. Applicant reserves the right to change any originally filed claim or file any new claim accordingly, including the right to be able to amend any originally filed claim to depend from and/or incorporate any feature of any other claim although not originally claimed in that manner. These and other objects and/or aspects of the present inventive concept are explained in detail below.

### BRIEF DESCRIPTION OF THE DRAWINGS

The accompanying drawings, which form a part of the specification, illustrate various embodiments of the present inventive concept. The drawings and description together serve to fully explain embodiments of the present inventive concept.

FIGS. 1A-1C are perspective views of a conventional floating-type caliper brake system for a vehicle.

FIG. 2 is a perspective view of a disc brake assembly, according to some embodiments of the present inventive concept.

FIGS. 3A-3B are perspective views of the brake pad carrier of the disc brake assembly of FIG. 2.

FIGS. 4A-4B are perspective views of the brake pad carrier of FIGS. 3A-3B with brake pad retention clips according to embodiments of the present inventive concept secured thereto.

FIG. 5A is a perspective view of a disc brake pad, according to some embodiments of the present inventive concept.

FIG. 5B is a plan view of the disc brake pad of FIG. 5A.

FIGS. 6A-6B are front perspective views of brake pad retention clips, according to some embodiments of the present inventive concept.

FIGS. 7A-7B are rear perspective views of the brake pad retention clips of FIGS. 6A-6B.

FIGS. 8A-8B are front views of the brake pad retention clips of FIGS. 6A-6B.

FIGS. 9A-9B are side views of the brake pad retention clips of FIGS. 6A-6B.

### DETAILED DESCRIPTION

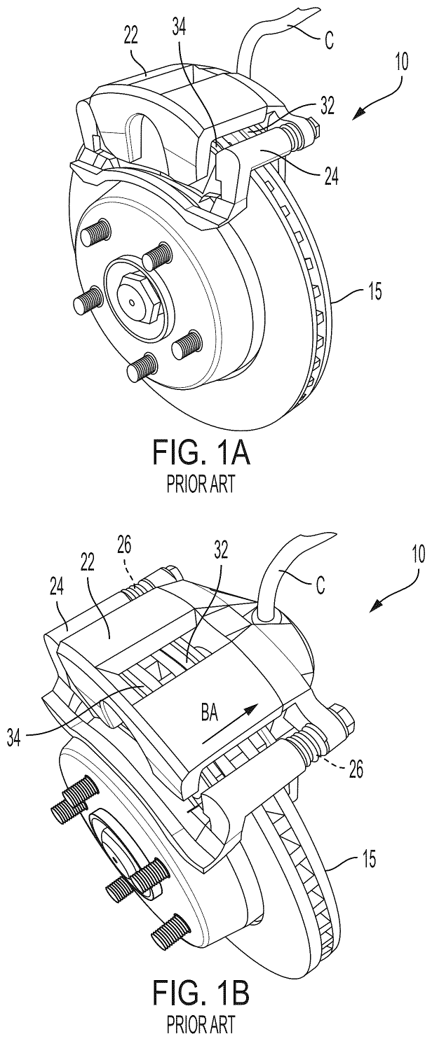

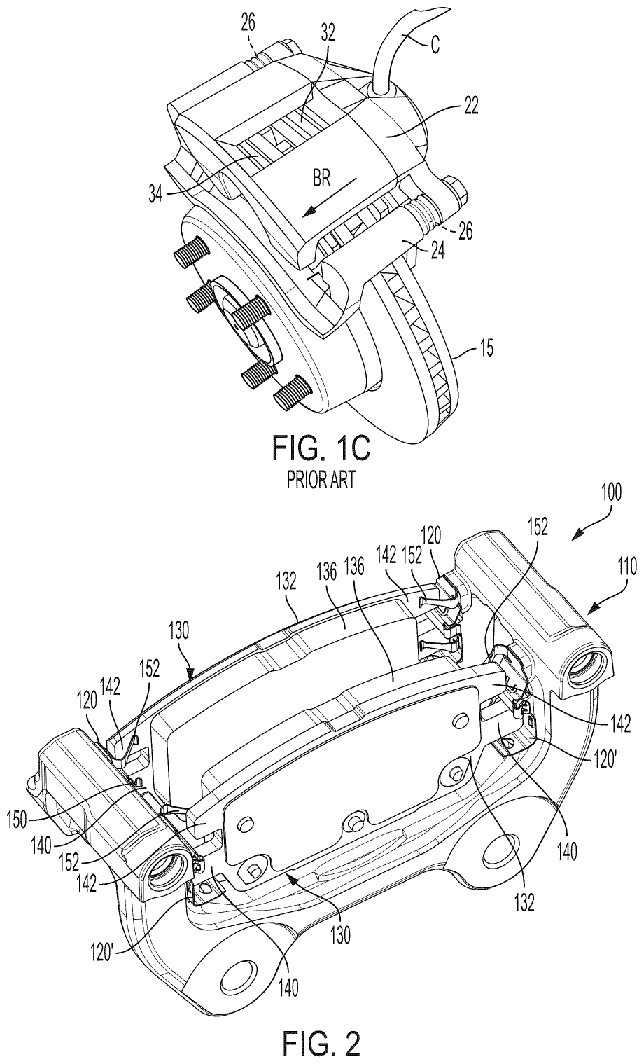

Referring to FIG. 2, a disc brake assembly 100 according to embodiments of the present inventive concept is illustrated. The disc brake assembly 100 includes a brake pad carrier 110, a first pair of brake pad retention clips 120 secured to the brake pad carrier 110 in spaced apart relationship, a first disc brake pad 130 movably supported within the brake pad carrier 110 by the first pair of brake pad retention clips 120, a second pair of brake pad retention clips 120′ secured to the brake pad carrier 110 in spaced apart relationship, and a second disc brake pad 130 movably supported within the brake pad carrier 110 by the second pair of brake pad retention clips 120′. The first and second disc brake pads 130 are movably supported within the brake pad carrier 110 in spaced apart relationship such that a rotor (e.g., rotor 15 illustrated in FIGS. 1A, 1B, and 1C) associated with a vehicle wheel can be positioned therebetween.

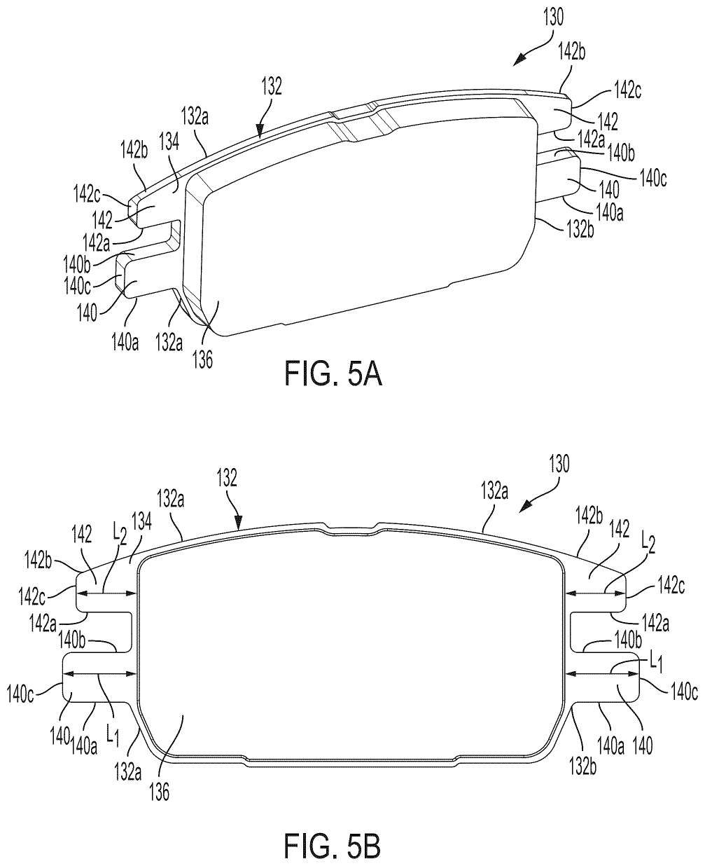

Referring to FIGS. 5A-5B, each of the first and second disc brake pads 130 includes a backing plate 132 having opposing end portions 132a, 132b and an inner surface 134 (i.e., a surface that faces the rotor). Friction material 136 is secured to the inner surface 134, for example, via bonding, fasteners, etc., as would be understood by one of skill in the art of the present inventive concept. Moreover, the friction material 136 may be one or more discrete bodies or sections of friction material. Each end portion 132a, 132b of the backing plate 132 includes first and second support tabs 140, 142 extending outward therefrom in adjacent, spaced apart relationship, as illustrated in FIGS. 5A-5B. In the illustrated embodiment, the first support tabs 140 of the disc brake pad 130 each have a generally elongate, rectangular configuration. For example, the first support tabs 140 each have a lower edge surface 140a, an opposite upper edge surface 140b, and a distal edge surface 140c that are substantially planar. The lower edge surface 140a and upper edge surface 140b of each of the first support tabs 140 are substantially parallel, as illustrated. The distal edge surface 140c of each of the first support tabs 140 is substantially perpendicular to the lower edge surface 140a and upper edge surface 140b, as illustrated.

Each of the second support tabs 142 has an arcuate upper edge surface 142b that coincides with the curvature of the upper edge surface 132a (also referred to as the upper end portion 132a) of the backing plate 132, as illustrated. Each of the second support tabs 142 also has an opposite lower edge surface 142a that is substantially planar and a distal edge surface 142c that is substantially planar and substantially perpendicular to the lower edge surface 142a. The lower edge surface 142a of each second support tab 142 is also substantially parallel with the lower edge surface 140a and upper edge surface 140b of the respective adjacent first support tab 140, as illustrated.

The generally planar lower edge surfaces 140a, 142a of the first and second support tabs 140, 142 are configured to slidably move along the generally planar lower walls 122a, 124a of the respective lower and upper guide portions 122, 124 of the brake pad retention clips 120, 120′. The first support tab 140 has a shape and configuration that is configured to be received within the lower guide portion 122 of the brake pad retention clips 120, 120′, and the second support tab 142 has a shape and configuration that is configured to be received within the upper guide portion 124 of the brake pad retention clips 120, 120′. In the illustrated embodiment, the first support tab 140 has a length L₁ that is greater than a length L₂ of the second support tab 142. However, embodiments of the present inventive concept are not limited to the first support tab 140 having a greater length than the second support tab 142. In other embodiments, the first and second support tabs 140, 142 can have substantially the same length or the second support tab 142 may have a length greater than the length of the first support tab 140.

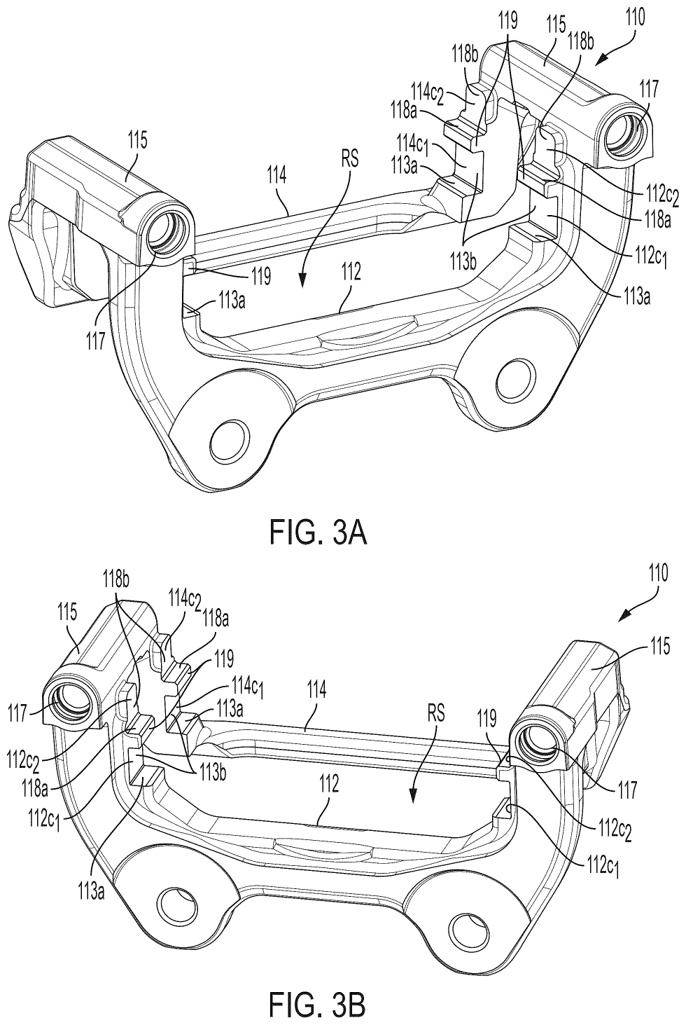

Referring to FIGS. 3A-3B, the illustrated brake pad carrier 110 of the disc brake assembly 100 includes an inner arm 112 and an outer arm 114 supported in spaced apart relationship by two connecting arms 115. Each connecting arm 115 includes a passageway 117 configured to receive a guide rod for movably coupling a caliper housing to the brake pad carrier 110, as would be understood by one of skill in the art of the present inventive concept. The brake pad carrier 110 may be secured to a stationary component of a vehicle, such as an axle flange or a steering knuckle, as would be understood by one of skill in the art of the present inventive concept. Between the inner arm 112 and the outer arm 114 of the brake pad carrier 110 is a rotor space RS, where a brake rotor (e.g., rotor 15 illustrated in FIGS. 1A, 1B, and 1C) would be located when the disc brake assembly 100 is positioned on a vehicle.

The first and second support tabs 140, 142 of a first disc brake pad 130 are configured to support the first disc brake pad 130 for sliding movement within respective channels 112C₁, 112C₂, of the inner arm 112 of the brake pad carrier 110. Similarly, the first and second support tabs 140, 142 of a second disc brake pad 130 are configured to support the second disc brake pad 130 for sliding movement within respective channels 114C₁, 114C₂, of the outer arm 114 of the brake pad carrier 110. The channels 112C₁, 112C₂ are provided on an inner wall of the inner arm 112 and may be substantially parallel to each other. Similarly, the channels 114C₁, 114C₂ are provided on an inner wall of the outer arm 114 and may be substantially parallel to each other. One or both of the channels 112C₁, 112C₂ may be formed on the inner arm 112 via a broach cut or other known method. Similarly, one or both of the channels 114C₁, 114C₂ may be formed on the outer arm 114 via a broach cut or other known method. For example, the brake pad carrier 110 may be machined to provide the surfaces that form the respective channels 112C₂, 114C₂ and the support tab or protrusion 119 to enable the brake pad retention clips 120, 120′ with the first and second spring retraction arms 150, 152 to be supported by the brake pad carrier 110.

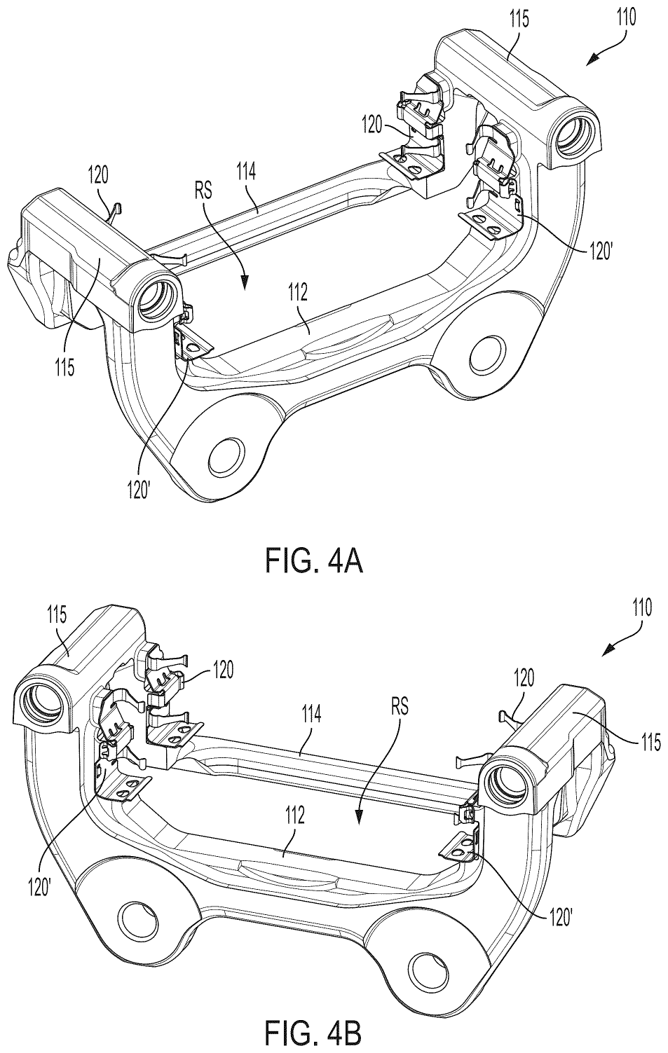

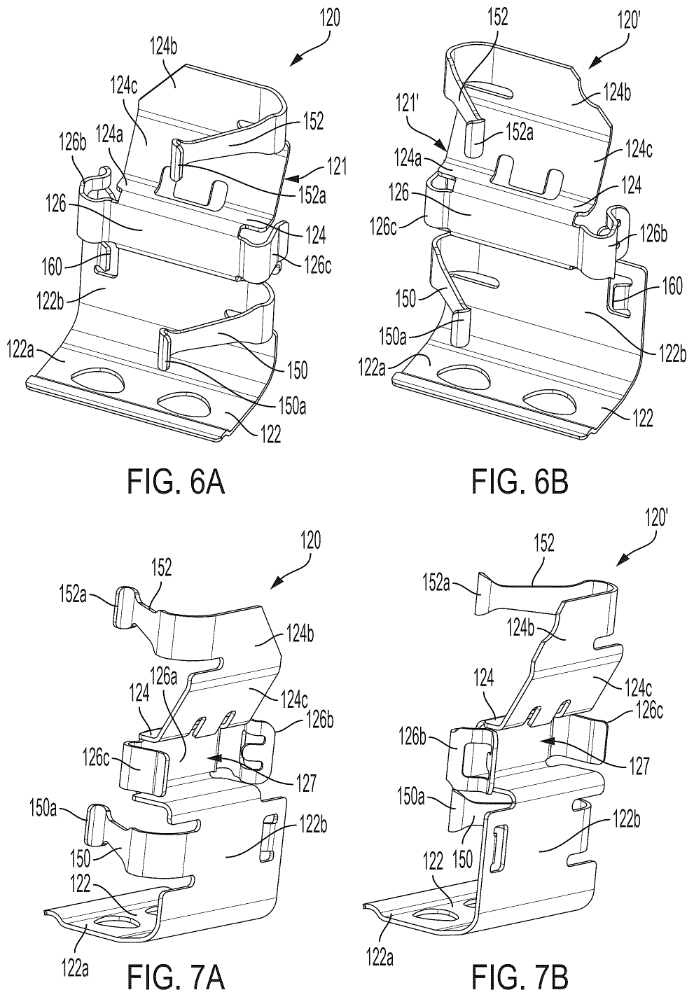

The channels 112C₁, 112C₂ and 114C₁, 114C₂ are configured to matingly receive the associated brake pad retention clips 120, 120′, as illustrated in FIGS. 4A-4B. Specifically, the brake pad retention clips 120 are received within channels 114C₁, 114C₂ of the outer arm 114, and the brake pad retention clips 120′ are received within channels 112C₁, 112C₂ of the inner arm 112. The disc brake pads 130 are then positioned within the brake pad carrier 110 such that each first support tab 140 is positioned within a lower guide portion 122 (FIGS. 6A, 6B) of a brake pad retention clip 120, 120′, and such that each second support tab 142 is positioned within an upper guide portion 124 (FIGS. 6A, 6B) of a brake pad retention clip 120, 120′. The brake pad retention clips 120, 120′, thus, support the disc brake pads 130 for movement within the brake pad carrier 110. The brake pad retention clips 120, 120′ may also help reduce vibrations/rattling of the disc brake pads 130 within the brake pad carrier 110 because of contact between the biasing members 150, 152 of the brake pad retention clips 120, 120′ and the first and second support tabs 140, 142 of the disc brake pads 130. The brake pad retention clips 120, 120′ are also configured to move the backing plates 132, and disc brake pads 130 associated therewith, away from a rotor (e.g., rotor 15 illustrated in FIGS. 1A, 1B, and 1C) via the first and second (double) spring retraction arms 150, 152 when a braking operation is over. Through the use of two spaced apart spring retraction arms 150, 152 contacting respective first and second support tabs 140, 142 on both (e.g., opposite) ends of a backing plate 132, the backing plate 132, and disc brake pad 130 associated therewith, can be uniformly moved away from a rotor (e.g., rotor 15 illustrated in FIGS. 1A, 1B, and 1C) and with more spring force than conventional braking systems.

Referring now to FIGS. 6A-6B, 7A-7B, 8A-8B, and 9A-9B, the brake pad retention clips 120, 120′ will be described. The brake pad retention clips 120, 120′ are identical in structure and configuration, but are mirror images of each other. Each brake pad retention clip 120, 120′ includes a lower guide portion 122 configured to slidably receive a first support tab 140 of a disc brake pad 130, an upper guide portion 124 configured to slidably receive a second support tab 142 of a disc brake pad 130, and an intermediate portion 126 that connects the lower guide portion 122 and the upper guide portion 124. The intermediate portion 126 is also configured to help secure each brake pad retention clip 120, 120′ to the protrusion 119 machined within the brake pad carrier 110. Each brake pad retention clip 120, 120′ may include one or more parts, such as protruding parts or retainers, to assist in securing the brake pad retention clip 120, 120′ to the brake pad carrier 110. In some embodiments, one or more parts of the brake pad retention clip 120, 120′ may be inserted into one or more of grooves, holes or notches formed in the brake pad carrier 110. For example, the protruding parts of the brake pad retention clip 120, 120′ may include, but are not limited to, reverse pointing tabs that can be configured and positioned to bite into or to increase friction when a force is applied to the brake pad retention clip 120, 120′ to remove the brake pad retention clip 120, 120′ from the brake pad carrier 110.

The lower guide portion 122 of each brake pad retention clip 120, 120′ includes a lower wall 122a configured to abut or be positioned proximate to the lower wall 113a of the channel 112C₁ and a rear wall 122b configured to abut or be positioned proximate to the rear wall 113b of channel 112C₁ when each brake pad retention clip 120, 120′ is mounted within the brake pad carrier 110. The upper guide portion 124 of each brake pad retention clip 120, 120′ includes a lower wall 124a configured to abut or be positioned proximate to the lower wall 118a of the channel 114C₂ and a rear wall 124b configured to abut or be positioned proximate to the rear wall 118b of channel 114C₂ when each brake pad retention clip 120, 120′ is mounted within the brake pad carrier 110. In the illustrated embodiment, the lower wall 124a and the rear wall 124b are connected by an angled intermediate wall 124c. As illustrated in FIGS. 9A-9B, the rear wall 122b of the lower guide portion 122 and the rear wall 124b of the upper guide portion are substantially co-planar.

The intermediate portion 126 of each brake pad retention clip 120, 120′ includes a wall 126a and opposing arms 126b, 126c that form a channel 127. When the brake pad retention clip 120, 120′ is coupled to the brake pad carrier 110, the channel 127 of the intermediate portion 126 is configured to removably receive the protrusion 119 that separates the respective channels 112C₁, 112C₂, of the inner arm 112 and the protrusion 119 that separates the respective channels 114C₁, 114C₂, of the outer arm 114. In the illustrated embodiment, the opposing arms 126b, 126c are deformable spring arms that grip the protrusion 119 to help secure the brake pad retention clip 120, 120′ to the brake pad carrier 110.

The lower guide portion 122 of each brake pad retention clip 120, 120′ includes a first biasing member or spring retraction arm 150, and the upper guide portion 124 of each brake pad retention clip 120, 120′ includes a second biasing member or spring retraction arm 152. In the illustrated embodiment, the first and second spring retraction arms 150, 152 of each brake pad retention clip 120, 120′ are deflectable spring arms or biasing members that each have a respective distal free end 150a, 152a. The first and second spring retraction arms 150, 152 engage and urge the respective first and second support tabs 140, 142 of each backing plate 132 and associated disc braking pad 130 away from a rotor (e.g., rotor 15 illustrated in FIGS. 1A, 1B, and 1C) when a braking operation is over. The increased spring force from the two spring retraction arms 150, 152 on each end portion of a respective backing plate 132 reduces or eliminates the occurrence of brake pad drag that may occur with conventional braking systems that utilize brake pad retention clips having only a single spring retraction arm. The terms “spring arm”, “retraction arm”, “biasing member”, and “spring retraction arm” may be used interchangeably herein.

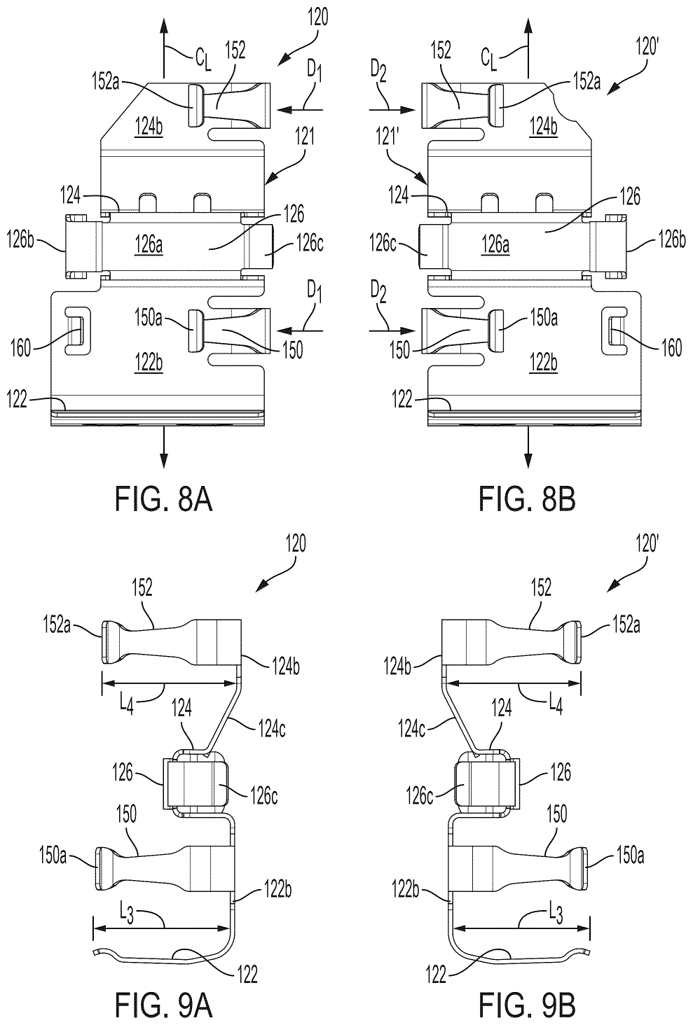

The first and second spring retraction arms 150, 152 of the brake pad retention clip 120 extend from the rotor side edge 121 of the brake pad retention clip 120, and the first and second spring retraction arms 150, 152 of the brake pad retention clip 120′ extend from the rotor side edge 121′ of the brake pad retention clip 120′, as illustrated in FIGS. 6A-6B and FIGS. 8A-8B. The first and second spring retraction arms 150, 152 of the brake pad retention clip 120 extend inward toward a centerline C_{L} of the brake pad retention clip 120, and the first and second spring retraction arms 150, 152 of the brake pad retention clip 120′ extend inward toward a centerline C_{L} of the brake pad retention clip 120′, as illustrated in FIGS. 8A-8B.

The distal free end 150a of the first spring retraction arm 150 is configured to contact the first support tab 140 of a backing plate 132 supporting a disc brake pad 130, and the distal free end 152a of the second spring retraction arm 152 is configured to contact the second support tab 142 of a backing plate 132 supporting a disc brake pad 130. When the disc brake pads 130 are pressed against a rotor during braking of a vehicle, the first and second support tabs 140, 142 of each backing plate 132 move against and deflect the first and second spring retraction arms 150, 152. This loads spring energy into the spring retraction arms 150, 152 by causing the spring retraction arms 150, 152 to bend or flex. When a braking force causing the disc brake pads 130 to press against the rotor is removed, the stored energy in the spring retraction arms 150, 152 urges the backing plates 132 and associated disc brake pads 130 away from the rotor (i.e., in a direction away from the rotor side edge 121, 121′ of each brake pad retention clip 120, 120′) as the spring retraction arms 150, 152 return to their original, unflexed configuration, as would be understood by one of skill in the art of the present inventive concept. For example, as illustrated in FIG. 8A, spring retraction arms 150, 152 of brake pad retention clip 120 are configured to move a backing plate 132 and associated disc brake pad 130 in the direction D₁ away from the rotor side edge 121 of brake pad retention clip 120. Similarly, in FIG. 8B, spring retraction arms 150, 152 of brake pad retention clip 120′ are configured to move a backing plate 132 and associated disc brake pad 130 in the direction D₂ away from the rotor side edge 121′ of brake pad retention clip 120′. The double (first and second) spring retraction arms 150, 152 of the brake pad retention clips 120, 120′ push each backing plate 132 in two locations at each end thereof, which helps increase the gap between each disc brake pad 130 and a rotor (e.g., rotor 15 illustrated in FIGS. 1A, 1B, and 1C) when a braking operation is ended, thereby reducing off brake drag and increasing brake pad life.

In the illustrated embodiment, the distal free end 150a of the first spring retraction arm 150 has an arcuate configuration that curves away from the lower guide portion 122, and the distal free end 152a of the second spring retraction arm 152 has an arcuate configuration that curves away from the upper guide portion 124. This arcuate configuration allows for sliding contact with the first and second support tabs 140, 142. Other configurations may be utilized, also, and embodiments of the present inventive concept are not limited to the illustrated distal end configuration of the spring retraction arms 150, 152. For example, in some embodiments, the distal free ends 150a, 152a of the spring retraction arms 150, 152 may have a sharp or blunt edge configuration that is angled relative to a respective support tab 140, 142 and that allows the distal free ends 150a, 152a of the spring retraction arms 150, 152 to slidably move along the first and second support tabs 140, 142 as the disc brake pad 130 moves against the spring retraction arms 150, 152 during a braking operation. Moreover, the spring retraction arms 150, 152 may have various other shapes and configurations and embodiments of the present inventive concept are not limited to the illustrated shape and configuration of the spring retraction arms 150, 152.

In the illustrated embodiment, the first and second spring retraction arms 150, 152 of each brake pad retention clip 120, 120′ are substantially parallel, as shown in FIGS. 8A-8B and FIGS. 9A-9B. In addition, the first spring retraction arm 150 of each brake pad retention clip 120, 120′ has a length L₃ from the rear wall 122b that is substantially equal to a length L₄ of the second spring retraction arm 152 from the rear wall 124b of each brake pad retention clip 120, 120′, as illustrated in FIGS. 8A-8B. However, embodiments of the present inventive concept are not limited to the first and second spring retraction arms 150, 152 being substantially parallel or to the first and second spring retraction arms 150, 152 having substantially the same length. The spring retraction arms 150, 152 can have various shapes, configurations and lengths. Moreover, the distal free ends 150a, 152a of the spring retraction arms 150, 152 can have various shapes and configurations.

In the illustrated embodiment, the lower guide portion 122 of each brake pad retention clip 120, 120′ includes a stop 160 that is configured to limit a distance the first support tab 140 of a backing plate 132 can move within the lower guide portion 122 in a direction away from the rotor side edge 121, 121′ of each brake pad retention clip 120, 120′. The illustrated stop 160 is a tab that is bent at an angle relative to the rear wall 122b of the brake pad retention clip 120, 120′ and so as to extend partially into the lower guide portion 122 thereof. Thus, the stop 160 and spring retraction arm 150 in the lower guide portion 122 also serve the function of retaining a backing plate 132 and associated disc brake pad 130 within the brake pad retention clip 120, 120′.

The brake pad retention clips 120, 120′ of the present inventive concept may be formed as a single unitary body. For example, the brake pad retention clips 120, 120′ may be injected molded, cast, bent, or otherwise formed from multiple pieces (e.g., laser or heat welding) to form a single unitary body.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises”, “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

What is claimed:

1. A brake pad retention clip configured to support a disc brake pad in a brake pad carrier, the disc brake pad having a backing plate with opposing end portions, each end portion having first and second support tabs extending outward therefrom in adjacent, spaced apart relationship, the brake pad retention clip comprising:
a lower guide portion configured to slidably receive the first support tab of one of the backing plate end portions, the lower guide portion comprising a first biasing member configured to contact the first support tab;
an upper guide portion configured to slidably receive the second support tab of the one of the backing plate end portions, the upper guide portion comprising a second biasing member configured to contact the second support tab; and
an intermediate portion connecting the lower guide portion and the upper guide portion, wherein the intermediate portion is configured to secure the brake pad retention clip to the brake pad carrier.

2. The brake pad retention clip of claim 1, wherein the first biasing member is a first deflectable spring arm comprising a distal free end that is configured to contact the first support tab, and wherein the second biasing member is a second deflectable spring arm comprising a distal free end that is configured to contact the second support tab.

3. The brake pad retention clip of claim 2, wherein the distal free end of the first spring arm has an arcuate configuration, and wherein the distal free end of the second spring arm has an arcuate configuration.

4. The brake pad retention clip of claim 2, wherein the first and second spring arms extend inward toward a centerline of the brake pad retention clip.

5. The brake pad retention clip of claim 2, wherein the first and second spring arms are substantially parallel.

6. The brake pad retention clip of claim 2, wherein the first and second spring arms have a same length.

7. The brake pad retention clip of claim 1, wherein the intermediate portion comprises opposing arms configured to engage a portion of the brake pad carrier.

8. The brake pad retention clip of claim 1, wherein the lower guide portion further comprises a stop configured to limit a distance the first support tab can move within the lower guide portion.

9. The brake pad retention clip of claim 1, wherein the brake pad retention clip is formed as a single unitary body.

10. A disc brake pad, comprising:
a backing plate comprising opposing end portions and an inner surface, wherein each end portion comprises first and second support tabs extending outward therefrom in adjacent, spaced apart relationship; and
friction material on the inner surface of the backing plate.

11. The disc brake pad of claim 10, wherein the first and second support tabs extending outward from each end portion are coplanar with the backing plate.

12. The disc brake pad of claim 10, wherein the first support tab has a length greater than a length of the second support tab.

13. A disc brake assembly, comprising:
a brake pad carrier;
a first pair of brake pad retention clips secured to the brake pad carrier in spaced apart relationship;
a first disc brake pad movably supported within the brake pad carrier by the first pair of brake pad retention clips;
a second pair of brake pad retention clips secured to the brake pad carrier in spaced apart relationship; and
a second disc brake pad movably supported within the brake pad carrier by the second pair of brake pad retention clips, wherein the first and second disc brake pads are supported within the brake pad carrier in spaced apart relationship such that a rotor associated with a vehicle wheel can be positioned therebetween;
wherein each of the first and second disc brake pads comprises:
a backing plate comprising opposing end portions and an inner surface, wherein each end portion comprises first and second support tabs extending outward therefrom in adjacent, spaced apart relationship; and
friction material on the inner surface of the backing plate; and
wherein each brake pad retention clip comprises:
a lower guide portion configured to slidably receive the first support tab of one of the backing plate end portions, wherein the lower guide portion comprises a first biasing member configured to contact the first support tab; and
an upper guide portion configured to slidably receive the second support tab of the one of the backing plate end portions, wherein the upper guide portion comprises a second biasing member configured to contact the second support tab.

14. The disc brake assembly of claim 13, wherein each brake pad retention clip further comprises an intermediate portion connecting the lower guide portion and the upper guide portion, and wherein the intermediate portion is configured to secure the brake pad retention clip to the brake pad carrier.

15. The disc brake assembly of claim 13, wherein the first biasing member is a first deflectable spring arm comprising a distal free end that is configured to contact the first support tab, and wherein the second biasing member is a second deflectable spring arm comprising a distal free end that is configured to contact the second support tab.

16. The disc brake assembly of claim 15, wherein the distal free end of the first spring arm has an arcuate configuration, and wherein the distal free end of the second spring arm has an arcuate configuration.

17. The disc brake assembly of claim 15, wherein the first and second spring arms extend inward toward a centerline of the brake pad retention clip and are substantially parallel.

18. The disc brake assembly of claim 15, wherein the first and second spring arms have a same length.

19. The disc brake assembly of claim 14, wherein the intermediate portion comprises opposing arms configured to engage a portion of the brake pad carrier.

20. The disc brake assembly of claim 13, wherein the lower guide portion further comprises a stop configured to limit a distance the first support tab can move within the lower guide portion.
